(19) United States
(12) Patent Application Publication
(10) Pub. No.: US 2010/0050215 A1
(43) Pub. Date: Feb. 25, 2010

(54) SYSTEM AND METHOD FOR BANDWIDTH HANDLING

(75) Inventors: Per-Ola Wester, Enskede (SE); Bruce Horowitz, Stockholm (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: TELIASONERA AB, Stockholm (SE)

(21) Appl. No.: 12/516,242

(22) PCT Filed: Nov. 27, 2007
(86) PCT No.: PCT/SE2007/001045

§ 371 Date: Sep. 2, 2009

(30) Foreign Application Priority Data
Dec. 1, 2006 (SE) 0602578-7
Jul. 4, 2007 (SE) 0701654-6

(51) Int. Cl. H04N 7/18

(52) U.S. Cl. 725/82

(57) ABSTRACT

A system and method for monitoring and distributing available bandwidth within a home network by- use of a home gateway is provided. The system comprises a home Gateway, one or several Set-Top Boxes and one or several home display units such as e.g. a TV, mobile phone and personal computer When the user selects a movie, a point-to-point unicast connection is set up between the user's set-top-box and the delivering streaming server located outside the local network. Accordingly, the home gateway receives a request signal for a displaying a movie from the set-top box, which signal includes bandwidth information, the home gateway monitor the home gateway if there is available bandwidth. An accept signal will be sent to the STB if there is available bandwidth and the set-top box will send an join-message to the delivering streaming server and the movie is displayed on the home device.

### FIELD OF THE INVENTION

The present invention relates to the field of bandwidth handling. More particularly, the invention relates to a system and method for bandwidth handling in a Home network for Internet Protocol Television (IPTV).

### BACKGROUND

IPTV is a system where a digital television service is delivered through traditional formats and cabling, that is using the internet protocol over a network infrastructure, and is received by the viewer through the technologies used for computer networks. For home users, IPTV is often provided in conjunction with Video on Demand (VoD) and may be bundled with Internet services such as Web access and Voice over IP (VoIP). IPTV is typically supplied by a broadband operator using a closed network infrastructure. This closed network approach is in competition with the delivery of TV content over the public internet, usually called TV over Internet or Internet Television.

IPTV channels require only an Internet connection and an Internet enabled device such as a personal computer, HDTV connected to a computer or a mobile phone to watch the IPTV broadcast.

IPTV uses a two-way digital broadcast signal sent through a switched telephone or cable network, a switched IP network, by way of a broadband connection and a Set-Top Box (STB) programmed with software that can handle viewer request to access many available media sources.

The term set-top box (STB) describes a device that connects to a television and some external sources of signal, and turns the signal into content then displayed on the screen. It descrambles the premium channels and provides a tuner for the higher cable numbers that very old TV sets did not support. Originally only analog/digital set-top boxes have become widely used for digital services that offers an on-screen program guide. Digital set-top boxes that provide high-definition TV (HDTV) are the latest version. In IPTV networks the set-top box (STB) is a small computer providing two-way communication on an IP network, and decoding the video streaming media.

In a typical TV or satellite network, using broadcast video technology, all the content flows constantly downstream to each user, and the user switches the content at the STB. The customer may select from as many choices as the telecoms, cable or Satellite Company can stuff into the “pipe” flowing into the home.

The residential or home IPTV is expected to grow as broadband is becoming available to more households and television broadcasters worldwide are transmitting their broadcast signal over Internet.

In many network elements, such as routers, switches and xDSL implementations, there is a bandwidth limitation and different user has different bandwidth. To be able to launch HDTV or several STB per customer it is important to have a mechanism that controls the availability bandwidth.

A know solution is to use a switched IP network where contents remains in the network and only the content the user selects is sent into the user's home. That frees up bandwidth and the user's choice is less restricted by the size of the “pipe” into the home.

This mechanism is provided on the network side and the cost for this mechanism will be carried by all subscribers, not just those utilizing the IPTV services.

Thus, there is a need for a new system and method for controlling and handling the availability bandwidth.

### SUMMARY OF THE INVENTION

Accordingly, it is an object of the present invention to provide a system and method for handling bandwidth within a Home network and to be informed from home devices (STB, PC and mobile) before the home devices (TV or VoD) change channel. The communication is done by using UPnP (universal Plug and play) protocol. This protocol is widely accepted in the Home area.

The object is met with a system and method for monitoring and distributing available bandwidth within the home network by use of a home gateway.

In a first aspect of the invention a system is provided for monitoring the usage of bandwidth based on the request for displaying broadcast programs in the household.

In another aspect of the invention a method is provided to accept or reject requests to display requested broadcast programs.

The present invention has the advantage over the prior art that the home network may be much simpler, which will lower the cost both in equipment and management.

Further it is a dynamic solution. Today it is difficult to launch HDTV or more than one STB per household in IPTV due to the fact that every user has different bandwidth in xDSL.

Thus, there is a need for a system and method for monitoring if there is enough bandwidth to deliver a broadcast program, such as a HDTV or VoD, or not. The present invention solves this problem with small development costs without impact on the Business Support System (BSS) or Operation Support system (OSS).

### BRIEF DESCRIPTION OF THE DRAWINGS

Further objects, features and advantages of the invention will become apparent from the following description of several embodiments of the invention with reference to the drawings, in which:

FIG. 1 illustrates a Home access network for IPTV;

FIG. 2 is schematic view of the signalling between the elements in the case of available bandwidth;

FIG. 3 is a schematic view of the signalling between the elements in the case of no available bandwidth; and

FIG. 4 is a schematic view of a home gateway device.

### DETAILED DESCRIPTION

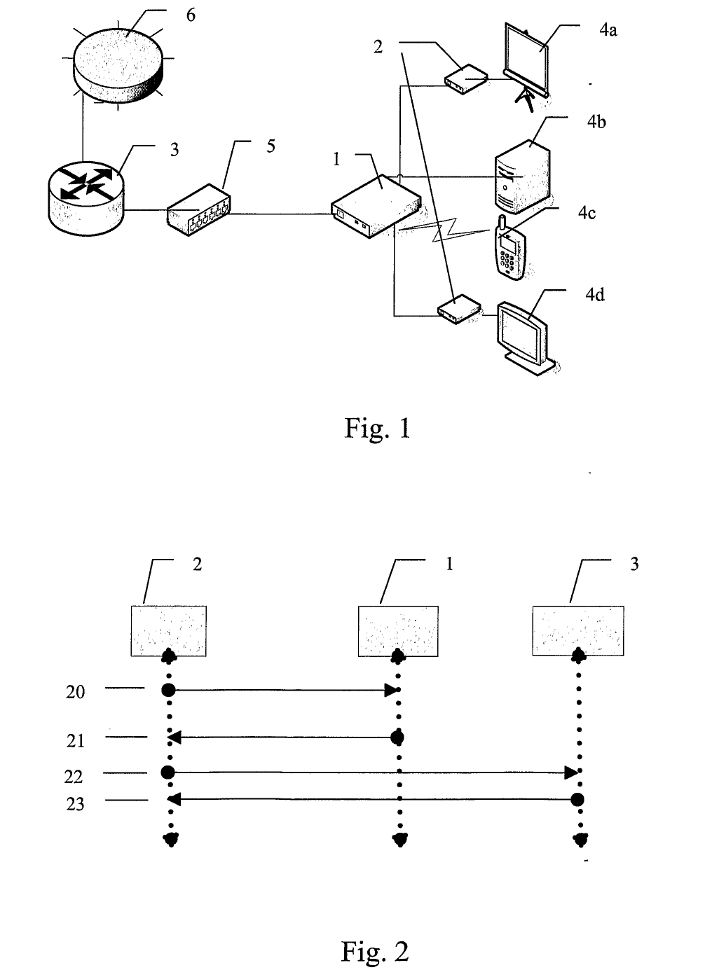

FIG. 1 illustrates a home access network for IPTV.

Many home users have special devices-called residential gateway or home gateway (HG), which are often referred to as routers. A router acts as a junction between two or more networks to buffer and transfer data packets among them. So for example, a router at home (a home gateway) 1 connects the Internet service provider's (ISP) network (usually an internet address) 6 with a Local area network (LAN) at home.

The system of the present invention comprises a Home Gateway (HG) device 1, one or several Set-Top Boxes (STB) 2 and one or several home display units 4a, 4b, 4c, 4d, such as e.g. a TV, mobile phone and personal computer. The communication between the HG 1, STB 2 and router 3 may be handled with the UPnP protocol, which is used for automatically configuring devices, discovering services and providing peer-to peer data transfer over an IP network. This protocol is widely accepted in the home area. Other alternative protocols may also be used.

The primary underlying protocols used for live TV is the Internet Group Management Protocol (IGMP) and for VoD is the Real time Streaming Protocol (RTSP).

IGMP governs the management of multicast groups in a TCP/IP network. To sign up for a multicast group, a Host Membership Report is sent by a user's machine 4a, 4b, 4c, 4d to its nearest router, the home gateway 1, which forward that data to router 3 outside the local network.

RSTP assures the signalling from trick play functionality, such as pause, slow-motion, wind/rewind etc.

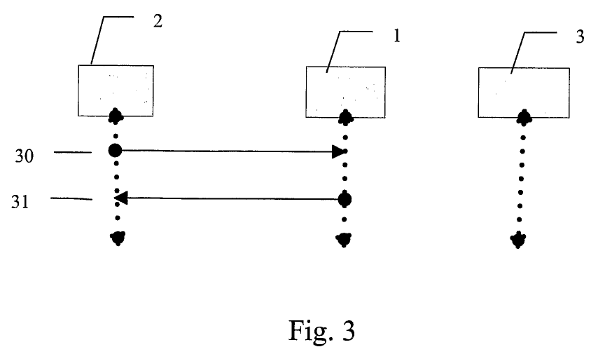

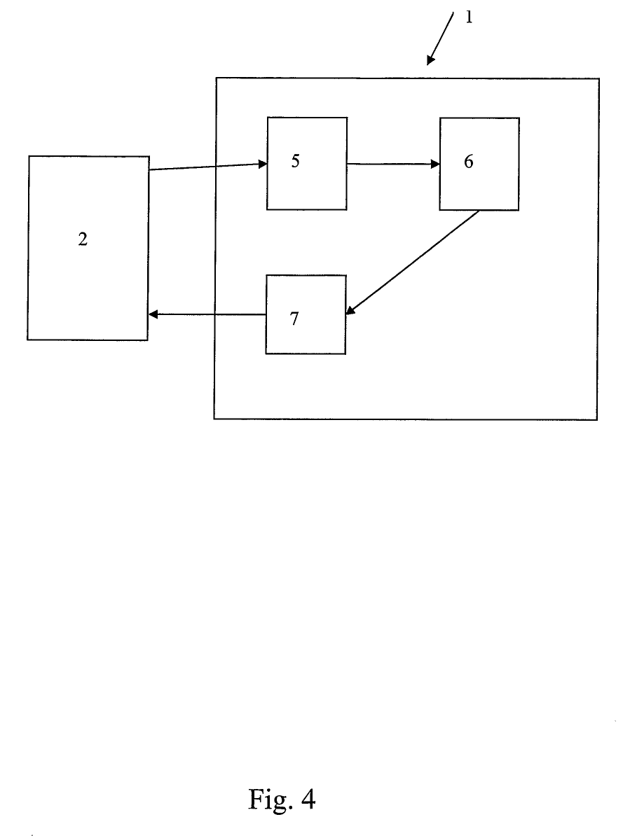

When the user selects a movie, a point-to-point unicast connection is set up between the user's set-top-box and the delivering streaming server located outside the local network. The signalling processes are shown in FIG. 2 and FIG. 3.

FIG. 2 illustrates the signalling process in the case where there is available bandwidth within the home network. First HG 1 receives an UPnP request 20 for a broadcast program, e.g. HDTV or VoD, from a STB 2. Bandwidth information is included in the request signal. Requested bandwidth for HDTV may be 10Mbit/s and for VoD it may be 5Mbit/s. HG monitor if there is available bandwidth within the home network. An UPnP accept signal 21 will be sent to the STB 2 if there is available bandwidth. If the request is for HDTV the STB 2 will send an IGMP join-message 22 to the router 3, which forward the request to the delivering streaming server, not shown, outside the local home network and the HDTV signal is sent 23 from the server through the router 3 to the STB 2 , which forward the HDTV signal to the home device 4a, 4b, 4c, 4d e.g. a TV, which requested the broadcast program. If the request is for VoD a RSTP Setup Void session message 22 will be sent to the router 3, which forward the request to the delivering streaming server, not shown, outside the local home network and the VoD signal is sent 23 from the server through the router 3 to the STB 2, which forward the VoD signal to the home device 4a, 4b, 4c, 4d, which requested the broadcast program. In this case the bandwidth information is included in the UPnP request 20 from the STB 2.

FIG. 3 illustrates the signalling process in the case where there is no available bandwidth. A UPnP request 30 for a broadcast program is sent to HG 1 from the STB 2. HG monitor if there is available bandwidth. In this case there is no available bandwidth and an UPnP reject request (31) will be sent to the STB 2.

All join and leave messages are monitored by the HG, which is already done in the HG of today. The HG will accept all join messages if there is available bandwidth but will handle UPnP request of bandwidth allocation with higher priority. If an UPnP request for bandwidth is incoming and there is no bandwidth free, it will be rejected. However if the current bandwidth usage is TCP traffic the request will be accepted and the TCP traffic will be dropped. The same behaviour is the way IPTV is working today, where TCP or other traffic will be dropped when TV is running. The bandwidth information shall always be included in the request. The bandwidth information is included in the program information each IPTV device has.

A similar mechanism may be used for other IP services e.g. telephony services.

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

To facilitate an understanding of the present invention a glossary of the abbreviations used in the specification is set out below:
IPTV: Internet Protocol Television
HDTV: High Definition TV
STB: Set Top Box
HG: Home Gateway
VoD: Video on Demand
UPnP: Universal Plug and Play
IGMP: Internet Group Multicast Protocol
xDSL: generally DSL (digital subscriber line)
OSS: Operation Support System
BSS: Business Support system

1. A system for bandwidth handling in a home network, said home network comprising:
a home gateway for communicating with a network infrastructure through a router devices, at least one set-top box for transmitting signals between at least one display unit and said home gateway, characterised in that said home gateway comprises: a receiving unit for receiving a first request signal for displaying a broadcast program, which signal comprises bandwidth information of said broadcast program, from one of said at least one display unit via one of said at least one set-top box; a monitoring unit for monitoring said home network for available bandwidth and which unit is configured to provide an answer signal based on available bandwidth and said bandwidth information; and a transmitting unit for transmitting said answer signal to said one of said at least one set-top box.

2. The system according to claim 1, wherein said monitoring unit is providing an answer signal which is an accept signal if there is available bandwidth for displaying said requested broadcast program and said set-top box is transmitting a join request to said router or a reject signal if there is no available bandwidth for displaying said requested broadcast program.

3. The system according to claim 2, wherein said monitoring unit is providing an answer signal based on whether said first request-signal is an UPnP request-signal or a TCP request-signal.

4. A method of monitoring bandwidth distribution within a home network, which network comprises a home gateway, at least one set-top box, a display device, wherein said home network is communicating with a network infrastructure through a router device characterised by the steps of: receiving, at said set-top box, a first request signal from said display device for a broadcast program, wherein said first request signal comprises bandwidth information on said broadcast program; transmitting said first request signal to said home gateway; monitoring, at said home gateway, said home network for available bandwidth, based on said bandwidth information; creating a answer signal using information regarding available bandwidth in said home network; and transmitting said answer signal to said set-top box.

5. The method according to claim 4, wherein said answer signal will be an accept signal if there is available bandwidth and or a reject signal if there is no available bandwidth, further comprising a step of: transmitting a join signal from said set-top box to said router if said answer signal is an accept signal.

6. The method according to claim 4, wherein said creation of an answer signal is based on whether said first request signal is an UPnP request or a TCP request.
